(19) United States
(12) Patent Application Publication
(10) Pub. No.: US 2025/0137864 A1
(43) Pub. Date: May 1, 2025

(54) METHOD AND SYSTEM FOR MONITORING MEASUREMENTS OF STATIC-PRESSURE PROBES OF AN AIRCRAFT

(71) Applicant: Airbus Operations (S.A.S.), Toulouse (FR)

(72) Inventor: Martin Delporte, Toulouse (FR)

(21) Appl. No.: 18/917,113

(22) Filed: Oct. 16, 2024

(30) Foreign Application Priority Data
Oct. 19, 2023 (FR) 2311322

(51) Int. Cl. G01L 27/00; B64F 5/60

(52) U.S. Cl. CPC G01L 27/007; B64F 5/60

(57) ABSTRACT

To detect a measurement error in a pair of right-left static-pressure probes of an aircraft, a system including electronic circuitry is configured to obtain right/left static-pressure measurements from the pair of right-left static-pressure probes, compute a right-left static-pressure differential from the obtained measurements, determine a theoretical right-left static-pressure differential using data from other equipment of the aircraft, compare the difference between the computed right-left differential and the determined theoretical right-left differential with a predetermined threshold, and when the comparison shows that the difference between the computed right-left differential and the determined theoretical right-left differential is greater than the predetermined threshold, generate a static-pressure-measurement error warning. Thus, it is possible to finely detect any errors in static-pressure measurements.

### TECHNICAL FIELD

The disclosure herein relates to a method and system for monitoring measurements of static-pressure probes of an aircraft with a view, more particularly, to detecting any errors in measurements of these static-pressure probes.

### BACKGROUND

On aircraft, static pressure is measured by virtue of a pair of probes installed symmetrically on either side of the fuselage of the aircraft in question. Thus, reference is made to right-left static-pressure probes.

Certain ADIRU systems (ADIRU standing for Air Data Inertial Reference Unit) monitor in real time the right-left differential between the static-pressure measurements taken. When this differential exceeds a predefined threshold, for example 30 millibars, the ADIRU system in question concludes that static-pressure measurement errors are present.

However, although this approach allows measurement errors to be correctly detected, it would be desirable to provide a solution that would allow any errors in static-pressure measurements to be detected even more finely.

### SUMMARY

Thus, a method for detecting a measurement error in a pair of right-left static-pressure probes of an aircraft is provided here, the method being implemented by a system taking the form of electronic circuitry, the method comprising the following steps: obtaining right/left static-pressure measurements from the pair of right-left static-pressure probes, which forms a first set of equipment of the aircraft; computing a right-left static-pressure differential ΔPsi from the obtained measurements; determining a theoretical right-left static-pressure differential ΔPsiₜₕₑₒ from a second set of equipment of the aircraft that is distinct from the first set of equipment; comparing the difference between the computed right-left differential ΔPsi and the determined theoretical right-left differential ΔPsiₜₕₑₒ with a predetermined threshold; and when the comparison shows that the difference between the computed right-left differential ΔPsi and the determined theoretical right-left differential ΔPsiₜₕₑₒ is greater than the predetermined threshold, generating a static-pressure-measurement error warning.

Thus, it is possible to finely detect any errors in static-pressure measurements.

In an embodiment, determining the theoretical right-left static-pressure differential ΔPsiₜₕₑₒ comprises applying a function F for estimating the theoretical right-left static-pressure differential.

In an embodiment, the function F for estimating the theoretical right-left static-pressure differential is such that the theoretical right-left static-pressure differential ΔPsiₜₕₑₒ is computed in the following way:

$$] Δ {Psi}_{theo} = - {k}_{β} \cdot ( \frac{mg}{S \cdot {Cy}_{β}} \cdot {n}_{y} + Pdyn \cdot \frac{{Cy}_{δ r}}{{Cy}_{β}} \cdot δ r )$$

where:
k_{β} is a coefficient such that ΔKp_{β}=−k_{β}·β, where ΔKp_{β} is a sideslip differential between the right and the left of the fuselage of the aircraft;
m is the mass of the aircraft and g is the acceleration due to gravity;
S is the area of one wing of the aircraft;
Pdyn is the dynamic pressure;
Cy_{δr} is the gradient of the aerodynamic drag coefficient due to the deflection of the rudder of the aircraft;
Cy_{β} is the gradient of the aerodynamic drag coefficient due to the sideslip of the aircraft;
n_{y} is the lateral load factor; and
δr is the rudder deflection angle.

In an embodiment, the function F for estimating the theoretical right-left static-pressure differential is such that the theoretical right-left static-pressure differential ΔPsiₜₕₑₒ is computed in the following way:

$$Δ {Psi}_{theo} = - \frac{{k}_{β} \cdot Pdyn}{{Cy}_{β}} \cdot ( Cz \cdot sin ϕ + {Cy}_{δ r} \cdot δ r )$$

where:
k_{β} is a coefficient such that ΔKp_{β}=−k_{β}·β, where ΔKp_{β} is a sideslip differential between the right and the left of the fuselage of the aircraft;
Pdyn is the dynamic pressure;
Cy_{δr} is the gradient of the aerodynamic drag coefficient due to the deflection of the rudder of the aircraft;
Cz is the lift coefficient; and
ϕ is the angle of inclination of the aircraft.

In an embodiment, determining a theoretical right-left static-pressure differential ΔPsiₜₕₑₒ comprises using a trained neural network that receives as inputs the following dataset:
n_{y}·m, where n_{y} is the lateral load factor and m is the mass of the aircraft;
the angle of attack α of the aircraft;
the angle of deflection of the rudder δr of the aircraft;
the engine-speed differential ΔN1 between an engine to the right of the fuselage and an engine to the left of the fuselage of the aircraft; and
the Mach number.

Also provided here is a computer program product comprising instructions that cause the method according to any of the embodiments presented above to be implemented when the instructions are executed by a processor. Also provided here is a data storage medium on which are stored instructions that cause the method according to any of the embodiments presented above to be implemented when the instructions are read from the data storage medium and executed by a processor.

Also provided here is a system for monitoring measurements of a pair of right-left static-pressure probes of an aircraft, the system taking the form of electronic circuitry configured to: obtain right/left static-pressure measurements from the pair of right-left static-pressure probes, which forms a first set of equipment of the aircraft; compute a right-left static-pressure differential ΔPsi from the obtained measurements; determine a theoretical right-left static-pressure differential ΔPsiₜₕₑₒ from a second set of equipment of the aircraft that is distinct from the first set of equipment; compare the difference between the computed right-left differential ΔPsi and the determined theoretical right-left differential ΔPsiₜₕₑₒ with a predetermined threshold; and when the comparison shows that the difference between the computed right-left differential ΔPsi and the determined theoretical right-left differential ΔPsiₜₕₑₒ is greater than the predetermined threshold, generate a static-pressure-measurement error warning.

Also provided here is an aircraft comprising at least one pair of right-left static-pressure probes placed on either side of the fuselage, and at least one system for monitoring measurements of a pair of right-left static-pressure probes such as presented above.

### BRIEF DESCRIPTION OF THE DRAWINGS

The abovementioned features of the disclosure herein, as well as others, will become more clearly apparent on reading the following description of at least one example of embodiment, the description being given with reference to the appended drawings, in which:

FIG. 1 schematically illustrates an algorithm for monitoring measurements of static-pressure probes;

FIG. 2 schematically illustrates a first particular embodiment of a system for monitoring measurements of static-pressure probes;

FIG. 3 schematically illustrates a second particular embodiment of the system for monitoring measurements of static-pressure probes;

FIG. 4 schematically illustrates one example of a hardware arrangement configured to implement the algorithm of FIG. 1; and

FIG. 5 schematically illustrates a side view of an aircraft equipped with a system for monitoring measurements of static-pressure probes.

### DETAILED DESCRIPTION

Below, various embodiments of a system for monitoring measurements of static-pressure probes of an aircraft are disclosed.

Such a system for monitoring measurements of static-pressure probes is intended to be used to monitor measurements made by right and left static-pressure probes of the aircraft. A side view of such an aircraft 500 has been schematically illustrated in FIG. 5.

Such a system for monitoring measurements of static-pressure probes is preferably integrated into an ADIRU system (ADIRU standing for Air Data Inertial Reference Unit) connected to such right and left static-pressure probes of the aircraft 500, i.e. placed symmetrically to the right and left of the fuselage of the aircraft 500. The ADIRU system is a system that delivers information on speed and altitude, and inertial references.

Detailed monitoring of measurements of static-pressure probes is typically complemented by other mechanisms for monitoring measurements of static-pressure probes.

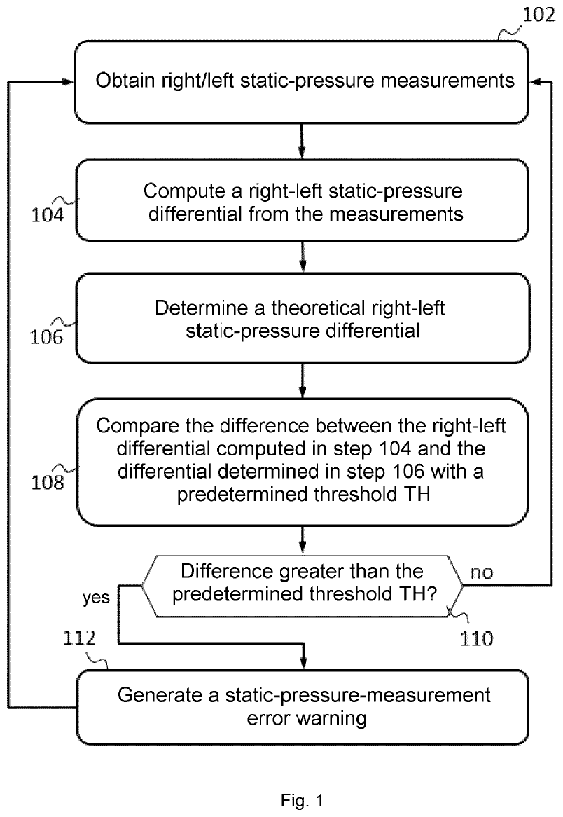

FIG. 1 schematically illustrates an algorithm for monitoring measurements of static-pressure probes. The algorithm of FIG. 1 is implemented by the aforementioned system for monitoring measurements of static-pressure probes.

In a step 102, the system for monitoring measurements of static-pressure probes obtains left and right measurements of the static-pressure probes. These measurements are thus obtained in real time from a first set of sensors formed by the static-pressure probes on the left and the right of the fuselage.

In a step 104, the system for monitoring measurements of static-pressure probes computes a right-left static-pressure differential (ΔPsi) from the measurements obtained in step 102.

In a step 106, the system for monitoring measurements of static-pressure probes determines a theoretical right-left static-pressure differential (ΔPsiₜₕₑₒ) from measurements and data obtained from a second set of sensors or equipment of the aircraft 500, which is distinct from the first set of sensors.

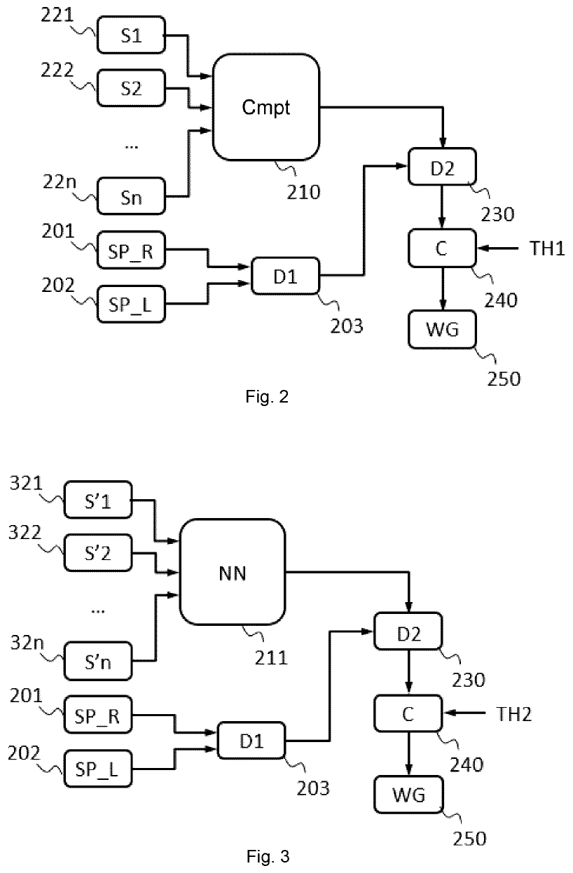

In a first embodiment, the system for monitoring measurements of static-pressure probes incorporates a computer for determining the theoretical right-left static-pressure differential (ΔPsiₜₕₑₒ). This first embodiment is presented below with reference to FIG. 2.

In a second embodiment, the system for monitoring measurements of static-pressure probes incorporates a trained neural network for determining the theoretical right-left static-pressure differential (ΔPsiₜₕₑₒ). This second embodiment is presented below with reference to FIG. 3.

In a step 108, the system for monitoring measurements of static-pressure probes compares the difference between the right-left differential computed in step 104 (ΔPsi) and the differential determined in step 106 (ΔPsiₜₕₑₒ) with a predetermined threshold TH.

In a step 110, the system for monitoring measurements of static-pressure probes verifies whether the difference between the right-left differential computed in step 104 and the differential determined in step 106 is greater than the predetermined threshold TH. If such is the case, a step 112 is carried out; otherwise, step 102 is repeated for a new real-time cycle of monitoring the measurements of static-pressure probes.

In step 112, the system for monitoring measurements of static-pressure probes generates a static-pressure-measurement error warning. For example, the warning is an audible and/or visual avionics signal. In another example, the warning is a signal or message indicating that the measurements from the static-pressure probes are potentially erroneous.

FIG. 2 schematically illustrates the system for monitoring measurements of static-pressure probes according to a first embodiment.

In FIG. 2, the system for monitoring measurements of static-pressure probes comprises a first differential circuit D1 203 configured to deliver as output a difference, in absolute value, between a first static-pressure measurement delivered as input by a right static-pressure probe SP_R 201 and a second static-pressure measurement delivered as input by a left static-pressure probe SP_L 202.

The system for monitoring measurements of static-pressure probes further comprises a computer 210 that receives as inputs data (e.g., measurements) generated by various sensors or equipment S1 221, S2 222 . . . . Sn 22n of the aircraft 500. The computer 210 applies a function F for estimating the theoretical right-left static-pressure differential. The theoretical right-left static-pressure differential is thus delivered as output by the computer 210.

In an embodiment, the function F is such that the theoretical right-left static-pressure differential ΔPsiₜₕₑₒ is computed in the following way:

$$] Δ {Psi}_{theo} = - {k}_{β} \cdot ( \frac{mg}{S \cdot {Cy}_{β}} \cdot {n}_{y} + Pdyn \cdot \frac{{Cy}_{δ r}}{{Cy}_{β}} \cdot δ r )$$

where:
k_{β} is a coefficient such that ΔKp_{β}=−k_{β}·β, where ΔKp_{β} is a sideslip differential between the right and the left of the fuselage;
m is the mass of the aircraft 500 and g is the acceleration due to gravity;
S is the area of a wing of the aircraft (N.B. this wing area serves as a common reference in determination of the aerodynamic coefficients);
Pdyn is the dynamic pressure;
Cy_{δr} is the gradient of the aerodynamic drag coefficient due to the deflection of the rudder of the aircraft;
Cy_{β} is the gradient of the aerodynamic drag coefficient due to the sideslip of the aircraft;
n_{y} is the lateral load factor; and
δr is the rudder deflection angle of the aircraft.

For example, the coefficient kg is obtained via flight tests, or wind-tunnel tests, or via computations, or via theoretical analysis.

It is known that, in aircraft, dynamic pressure Pdyn is computed based on the measurement of static pressure and on the measurement of total pressure Ptot. It should be understood that here it is a question of focusing on the differential in static-pressure measurements between the right and the left of the fuselage. Thus, even if a measurement contains an error, it leads to a small dynamic-pressure error, which does not call into question the ability to detect the difference between the two static-pressure measurements.

In another embodiment, the function F is such that the theoretical right-left static-pressure differential ΔPsiₜₕₑₒ is computed in the following way:

$$] Δ {Psi}_{theo} = - \frac{{k}_{β} \cdot Pdyn}{{Cy}_{β}} \cdot ( Cz \cdot sin ϕ + {Cy}_{δ r} \cdot δ r )$$

where:
Cz is the aerodynamic lift coefficient; and
ϕ is the angle of inclination of the aircraft.

The system for monitoring measurements of static-pressure probes further comprises a second differential circuit D2 230 configured to deliver as output the difference, in absolute value, between the output of the first differential circuit D1 203 and the output of the computer 210 (i.e., the difference between the right-left differential computed in step 104 and the differential determined in step 106).

The system for monitoring measurements of static-pressure probes further comprises a comparator C 240 configured to compare the output of the second differential circuit D2 230 and a predetermined threshold TH. In this first embodiment, the predetermined threshold TH is, for example, equal to a value TH1 of 10 millibars.

The system for monitoring measurements of static-pressure probes further comprises a warning-generator circuit WG 250 configured to generate a static-pressure-measurement error warning, as described above, when the comparator output C 240 indicates that the output of the second differential circuit D2 230 is greater than the predetermined threshold TH.

FIG. 3 schematically illustrates the system for monitoring measurements of static-pressure probes according to a second embodiment.

In FIG. 3, the system for monitoring measurements of static-pressure probes comprises the first differential circuit D1 203 and the static-pressure probes SP_R 201 and SP_L 202, such as described above with reference to FIG. 2.

The system for monitoring measurements of static-pressure probes further comprises a neural network NN 211 trained to deliver as output an estimate of the theoretical right-left static-pressure differential depending on a set of data generated by various sensors or equipment S′1 321, S′2 322 . . . . Sn 32n of the aircraft 500.

The neural network NN 211 thus receives as inputs the following dataset:
n_{y}·m, where it will be recalled that n_{y} is the lateral load factor and m is the mass of the aircraft 500;
the angle of attack α of the aircraft 500;
δr, the rudder deflection angle of the aircraft;
ΔN1, the engine-speed differential between an engine to the right of the fuselage and an engine to the left of the fuselage; and
the Mach number.

A learning phase may be carried out by collecting these various data, and consolidated static-pressure measurements, in order to train the neural network NN 211 to evaluate the value of the theoretical right-left static-pressure differential ΔPsiₜₕₑₒ depending on the parameters listed above.

Once the training of the neural network NN 211 has been validated, the trained neural network NN 211 may be used in flight to determine the theoretical right-left static-pressure differential ΔPsiₜₕₑₒ depending on the real-time values of the parameters listed above.

The system for monitoring measurements of static-pressure probes also comprises the second differential circuit D2 230, the comparator C 240 and the warning-generator circuit WG 250, such as described above with reference to FIG. 2. Thus, the second differential circuit D2 230 is configured to deliver as output the difference, in absolute value, between the output of the first differential circuit D1 203 and the output of the neural network NN 211 (i.e., the difference between the right-left differential computed in step 104 and the differential determined in step 106).

In this second embodiment, the predetermined threshold TH is, for example, equal to a value TH2 of 5 millibars.

In one example of embodiment, the neural network NN 211 comprises a hidden layer with 15 nodes.

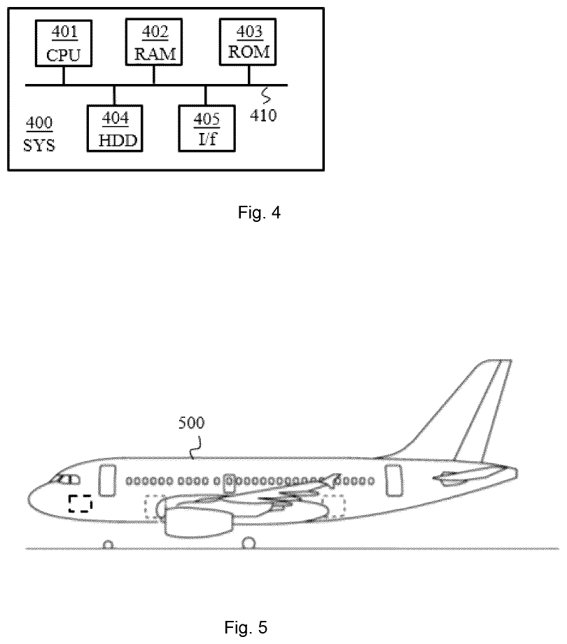

The arrangements presented above with reference to FIGS. 2 and 3 make it possible to implement, in the form of electronic circuits, a method according to the algorithm of FIG. 2. The algorithm of FIG. 2 may also be implemented in software form with a view to execution by a processor, as described below with reference to FIG. 4.

FIG. 4 thus schematically illustrates one example of a hardware platform configured to implement the system for monitoring measurements of static-pressure probes (referenced SYS 400 in FIG. 4) in the form of electronic circuitry.

The hardware platform then comprises the following, connected by a communication bus 410: a processor or central processing unit CPU 401; a random-access memory RAM 402; a read-only memory ROM 403, for example an electrically erasable programmable read-only memory (EEPROM), or a flash memory; a storage unit HDD 404, such as a hard disk drive or a storage device reader, such as an SD card reader (SD standing for Secure Digital); and an interface manager I/f 405.

The interface manager I/f 405 allows the hardware platform to interact with sensors on the aircraft 500. In one embodiment, the interface manager I/f 405 allows the hardware platform to interact with peripherals, such as human-machine-interface peripherals (cockpit display, etc.) of the aircraft 500.

The processor 401 is capable of executing instructions loaded into the random-access memory 402 from the read-only memory 403, from an external memory, from a storage medium (such as an SD card), or from a communication network. When the hardware platform is powered up, the processor 401 is capable of reading instructions from the random-access memory 402 and of executing them. These instructions form a computer program that causes the processor 401 to implement all or some of the steps described here.

All or some of the steps described here may thus be implemented in software form by executing a set of instructions by a programmable machine, for example a digital signal processor (DSP) or a microcontroller, or be implemented in hardware form by a machine or a dedicated electronic chip or a dedicated chipset. Generally, the system SYS 400 comprises electronic circuitry designed and configured to implement the steps described here.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for detecting a measurement error in a pair of right-left static-pressure probes of an aircraft, the method being implemented by a system comprising electronic circuitry, the method comprising:
obtaining right/left static-pressure measurements from the pair of right-left static-pressure probes, which forms a first set of equipment of the aircraft;
computing a right-left static-pressure differential ΔPsi from the obtained measurements;
determining a theoretical right-left static-pressure differential ΔPsiₜₕₑₒ from a second set of equipment of the aircraft that is distinct from the first set of equipment;
comparing a difference between the computed right-left differential ΔPsi and the determined theoretical right-left differential ΔPsiₜₕₑₒ with a predetermined threshold;
when the comparison shows that the difference between the computed right-left differential ΔPsi and the determined theoretical right-left differential ΔPsiₜₕₑₒ is greater than the predetermined threshold, generating a static-pressure-measurement error warning.

2. The method of claim 1, wherein determining a theoretical right-left static-pressure differential ΔPsiₜₕₑₒ comprises applying a function F for estimating the theoretical right-left static-pressure differential.

3. The method of claim 2, wherein the function F for estimating the theoretical right-left static-pressure differential is such that the theoretical right-left static-pressure differential ΔPsiₜₕₑₒ is computed by:
$$Δ {Psi}_{theo} = - {k}_{β} \cdot ( \frac{mg}{S \cdot {Cy}_{β}} \cdot {n}_{y} + Pdyn \cdot \frac{{Cy}_{δ r}}{{Cy}_{β}} \cdot δ r )$$
where:
k_{β} is a coefficient such that ΔKp_{β}=−k_{β}·β, where ΔKp_{β} is a sideslip differential between a right and a left of a fuselage of the aircraft;
m is a mass of the aircraft and g is an acceleration due to gravity;
S is an area of one wing of the aircraft;
Pdyn is a dynamic pressure;
Cy_{δr} is a gradient of an aerodynamic drag coefficient due to a deflection of a rudder of the aircraft;
Cy_{β} is a gradient of an aerodynamic drag coefficient due to a sideslip of the aircraft;
n_{y} is a lateral load factor; and
δᵣ is a rudder deflection angle of the aircraft.

4. The method of claim 2, wherein the function F for estimating the theoretical right-left static-pressure differential is such that the theoretical right-left static-pressure differential ΔPsiₜₕₑₒ is computed by:
$$Δ {Psi}_{theo} = - \frac{{k}_{β} \cdot Pdyn}{{Cy}_{β}} \cdot ( Cz \cdot sin ϕ + {Cy}_{δ r} \cdot δ r ) ere :$$
k_{β} is a coefficient such that ΔKp_{β}=−k_{β}·β, where ΔKp_{β} is a sideslip differential between a right and a left of a fuselage of the aircraft;
Pdyn is a dynamic pressure;
Cy_{δr} is a gradient of an aerodynamic drag coefficient due to a deflection of a rudder of the aircraft;
Cz is an aerodynamic lift coefficient; and
ϕ is an angle of inclination of the aircraft.

5. The method of claim 2, wherein determining a theoretical right-left static-pressure differential ΔPsiₜₕₑₒ comprises using a trained neural network that receives as inputs a following dataset:
n_{y}·m, where n_{y} is a lateral load factor and m is a mass of the aircraft;
an angle of attack α of the aircraft;
an angle of deflection of a rudder δr of the aircraft;
an engine-speed differential ΔN1 between an engine to a right of a fuselage and an engine to a left of the fuselage of the aircraft; and
a Mach number.

6. A computer program product comprising instructions that cause the method of claim 1 to be implemented when the instructions are executed by a processor.

7. A data storage medium on which are stored instructions that cause the method of claim 1 to be implemented when the instructions are read from the data storage medium and executed by a processor.

8. A system for monitoring measurements of a pair of right-left static-pressure probes of an aircraft, the system comprising electronic circuitry configured to:
obtain right/left static-pressure measurements from the pair of right-left static-pressure probes, which forms a first set of equipment of the aircraft;
compute a right-left static-pressure differential ΔPsi from the obtained measurements;
determine a theoretical right-left static-pressure differential ΔPsiₜₕₑₒ from a second set of equipment of the aircraft that is distinct from the first set of equipment;
compare the difference between the computed right-left differential ΔPsi and the determined theoretical right-left differential ΔPsiₜₕₑₒ with a predetermined threshold;
when the comparison shows that the difference between the computed right-left differential ΔPsi and the determined theoretical right-left differential ΔPsiₜₕₑₒ is greater than the predetermined threshold, generate a static-pressure-measurement error warning.

9. An aircraft comprising at least one pair of right-left static-pressure probes on either side of a fuselage of the aircraft, and at least one system for monitoring measurements of a pair of right-left static-pressure probes of claim 8.
